(19) United States
(12) Patent Application Publication
(10) Pub. No.: US 2021/0402705 A1
(43) Pub. Date: Dec. 30, 2021

(54) THREE-DIMENSIONAL PART PRINTABLILITY AND COST ANALYSIS

(71) Applicant: HEWLETT-PACKARD DEVELOPMENT COMPANY, L.P., Spring, TX (US)

(72) Inventors: Jeff Porter, Portland, OR (US); David Woodlock, Vancouver, WA (US); William E. Hertling, Vancouver, WA (US)

(21) Appl. No.: 16/605,562

(22) PCT Filed: Apr. 20, 2018
(86) PCT No.: PCT/US2018/028528

§ 371 Date: Oct. 16, 2019

(51) Int. Cl. B29C 64/393; G06Q 30/02; G06Q 30/06; B33Y 50/02; B33Y 10/00; B33Y 70/00

(52) U.S. Cl. CPC B29C 64/393; G06Q 30/0283; B33Y 70/00; B33Y 50/02; B33Y 10/00; G06Q 30/0631

(57) ABSTRACT

A method assigns one or more attributes of a part to be manufactured, based on received part data. A printability score and cost estimate of manufacturing the part is made.

### BACKGROUND

Injection molding is a type of manufacturing in which liquid material is injected into a mold whose internal cavity is the negative of the part being produced. The liquid material may comprise thermoplastic polymers, metals, or glass, for example.

Fused Deposition Modeling (FDM) and Selective Laser Melting (SLM) are two established types of three-dimensional (3D) printing. In addition to injection molding and 3D printing, there is also the option to machine a part, such as from metal, assemble the parts from multiple components, and other options. Thus, for a vendor of manufactured parts, an initial decision may be made to determine how a particular part should be manufactured. Each manufacturing approach has its positives and negatives, not the least of which is how much the part manufacture will cost and the quantity of parts being made.

### BRIEF DESCRIPTION OF THE DRAWINGS

Certain examples are described in the following detailed description and in reference to the drawings, in which:

FIGS. 1A and 1B are schematic block diagrams of methods for analyzing 3D part printability and cost, according to examples.

FIG. 2 is a simplified diagram of the user interface of the method of FIG. 1, according to examples.

FIG. 3 is an illustration of ways in which the meta-data used by the method of FIG. 1 may be obtained, according to examples.

FIG. 4 is an illustration of spider graphs used to evaluate a material to be replaced with two other materials, according to examples.

FIG. 5 is an illustration of a spider graph featuring six attributes, according to examples.

FIG. 6 is a graph illustrating a cost score versus a printability score for parts having assigned numerical values, according to examples.

FIG. 7 is a simplified block diagram of a system to implement the method of FIG. 1, according to examples.

FIG. 8 is a flow diagram of operations performed by the method of FIG. 1, according to examples.

FIG. 9 is a block diagram of a non-transitory, machine-readable medium for performing the method of FIG. 1, according to examples.

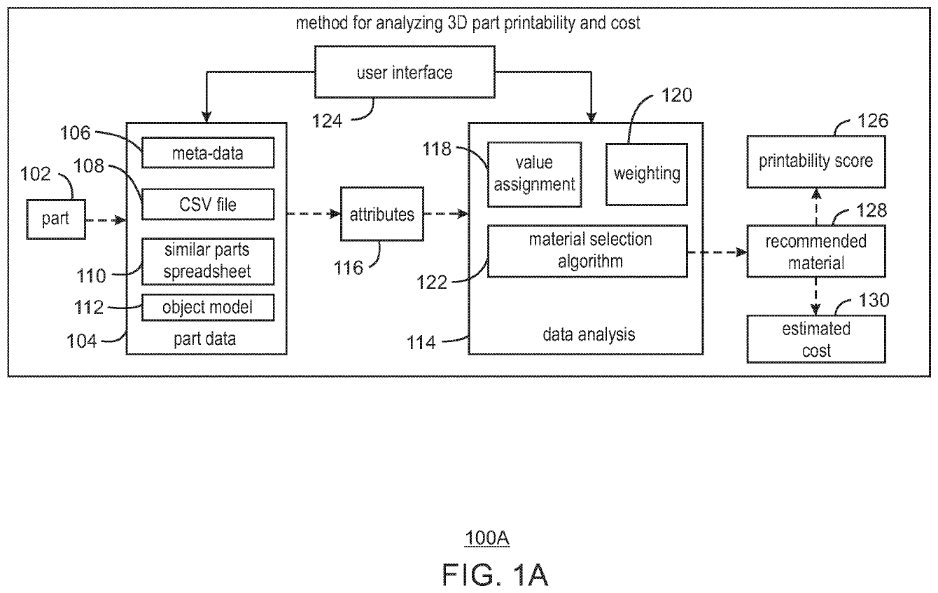

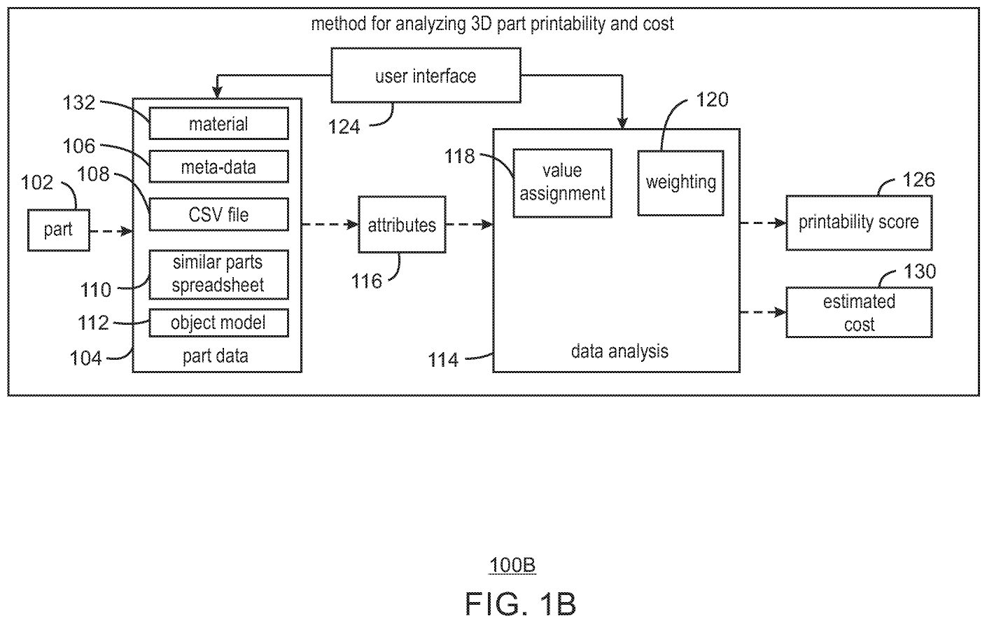

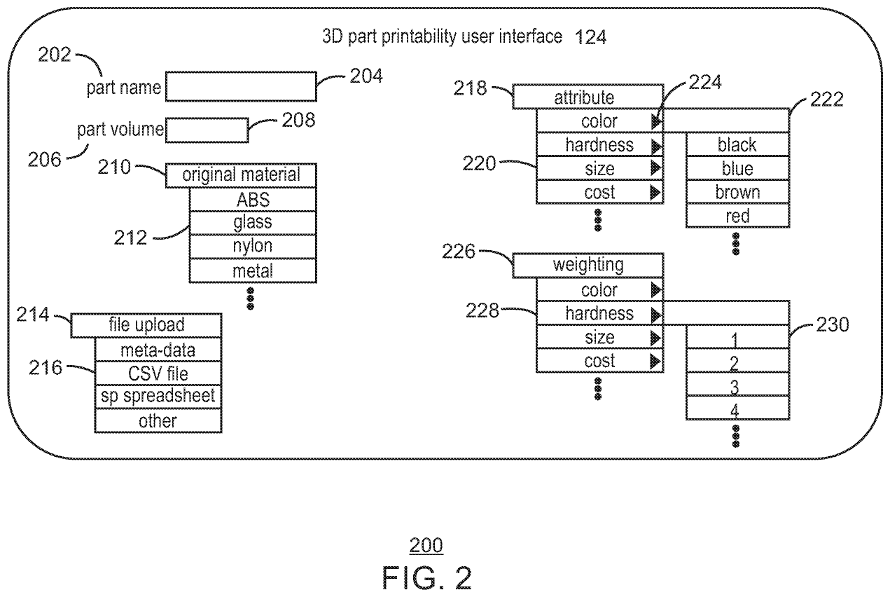

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

In accordance with the examples described herein, a system and method of analyzing 3D part printability and cost effectiveness are disclosed. Where options exist to machine, injection mold, assemble from multiple parts, or 3D print the part, the part is analyzed based on meta-data, a CSV file upload, a spreadsheet of similar parts, a 3D model of the part, or combinations thereof, and even user input data of the part are analyzed. Size, tensile strength, modulus, part tolerance, flammability, color, and cost may be among the characteristic data analyzed. During the analysis, a numerical value may be assigned to attributes, which may be weighted according to relative importance. A material recommendation is made, along with a printability score and estimated cost. The analysis draws from known information to estimate injection mold and machining costs while being innovative in the 3D print realm. The system and method employ a web-based interface in which characteristic data may be prompted for and received from a user.

The decision whether to machine, injection mold, assemble from multiple parts, or 3D print is not a trivial one for some part vendors. One approach may be to submit a hand-made prototype to someone with expertise in evaluating its printability and cost to manufacture. This is time consuming, labor intensive, and typically has a long turn-around time. Further, the evaluation may not scale to hundreds of thousands of parts. For example, a single manufacturer may sell 2,000 different products, and each product may contain an average of 300 different parts, for a total of 600,000 different parts, each of which may have a different production volume per year. Which of these parts may be suited to machining, 3D printing, or injection molding, may not be apparent by doing prototype evaluation.

Another approach is to use a spreadsheet that implements a cost algorithm for a part. The spreadsheet may contain different characteristics of the part, as an example, with the cost algorithm doing calculations based on the characteristics. Such a spreadsheet may be helpful to experts, but otherwise may not be usable to non-experts. The spreadsheet may change over time and thus may make maintaining a centralized and authoritative copy difficult. And, the spreadsheet, even where helpful, may not facilitate scaling to large numbers of parts.

FIGS. 1A and 1B are schematic block diagrams of methods 100A and 100B (collectively, “method 100” or “methods 100”) for analyzing 3D part printability and cost, according to examples. The methods 100A and 100B receives data 104 about a part 102 to be manufactured. Based on the received data 104, the method 100A performs data analysis 114, resulting in a recommended material 128, a printability score 126, and an estimated cost 130, to inform a manufacturer about the printability and cost to produce the part 102. The analysis 114 for the method 100A may involve a single material, two materials, or multiple materials. Further, the materials available to the 3D printers may be more limited than the choice available for the part being manufactured using other techniques.

By contrast, the method 100B may perform analysis without recommending a material, such as if the vendor specifies a material to be used. Thus, based on the received data, which may include a material 132 supplied as an input, the method 100B performs data analysis 114 and generate the printability score 126 and estimated cost 130 to produce the part 102, based on material recommended by the manufacturer. The material 132 provided as input to the method 100B may impact, for example, whether 3D printing is available, as the materials available to the 3D printer may be limited. Further, in some examples, this data analysis 114 facilitates selection between different manufacturing types, whether machining, injection molding, 3D printing, or other methods of manufacture. For both the method 100A (FIG. 1A) and the method 100B (FIG. 1B), the printability score 126 is a numerical value that indicates suitability for additive manufacturing, given zero or more constraints about the printer model, the available materials, available printer processes, and so on.

As illustrated in FIG. 1A, the method 100A receives data 104 about the part 102, which may be from a number of different sources. In one example, the part data 104 draws from meta-data 106 about the part, a comma separated value (CSV) file 108 of the part, and/or a similar parts spreadsheet (or database) 110 of the part. One or more data representations of the part may be publicly available, such as in the case of the similar parts spreadsheet 110, or may be available to the manufacturer of the part, such as in the meta-data 104 or CSV file 108. Or, the part data 104 may come from an object model 112 of the part 102. The part data 104 may be received directly, such as meta-data 106, may be provided, for example, as part of a CSV file 108 or spreadsheet 110, or may be extracted from analysis of the 3D model 112 of the part 102.

Additional part data may be obtained via the user interface 124. At a minimum, the volume of the part (e.g., the cubic volume) as well as the number of parts to be manufactured per year (the production volume) are received by way of the user interface 124, in one example. Additional data about the part 102 may include the desired material or material properties, the color, the dimensions (bounding box), and the actual shape of the part. In some examples, the methods 100A and 100B produce better results with more part data.

From the part data 104, attributes 116 are assigned to the part 102. The attributes 116 are in essence the characteristics of the part, and a part may have a small number of attributes, or may have many attributes, based in part on how much source part data 104 is available. The methods 100A and 100B then performs data analysis 114 based on the assigned attributes 116. The attributes 116 or characteristics of the part 102 may vary, depending on the part being produced. In addition to part and production volume described above, additional characteristics that may be gleaned from the part data 104, such as surface hardness, impact strength, elongation at break (e@B), size, tensile strength, flammability, creep resistance, color, and cost, are among the attributes 116 making up the data analysis 114 (any list herein of part attributes is not to be considered exhaustive).

In examples, each attribute 116 is assigned a numerical value 118 as well as a weighting 120, both of which are described in more detail below. From this data, the data analysis 114 of the method 100A invokes a materials selection algorithm 122 utilizing the value assignment 118 and weighting 120 of each attribute 116, resulting in the recommended material 128, from which a printability score 126 and estimated cost 130 are derived. The material selection algorithm 122, referred to herein in the singular, may actually comprise different algorithms for different materials, attributes, or categories of parts. When, as in FIG. 1B, the material 132 is provided as an input, the data analysis 114 is still performed, but no materials selection algorithm is invoked. Nevertheless, the printability score 126 and estimated cost 130 are provided.

From the recommended material 128, the printability score 126 is a numerical value assigned to the material. For example, a low (or high) printability score may indicate that the recommended material 128 is a good one for the part, given the value assignment 118 and weighting 120 of the attributes 116 during data analysis 114. Different objects to be printed with a given material will likely result in different printability scores. Similarly, the same object to be printed with different materials are likely to receive different printability scores. Thus, the combination of the part to be printed and the material yields the printability score. The estimated cost 130 indicates what the part 102 to be manufactured will cost using the recommended material 128, before the part is actually manufactured.

In one example, based on the attributes 116, the value assignments 118 and weightings 120 of the part to be manufactured 102, a single material is recommended by the materials selection algorithm 122. From the recommended material 128, the printability score 126 and estimated cost 130 are derived. In a second example, there may be different materials to be analyzed for the part 102. For each material, the materials selection algorithm 122 provides a printability score 126 and estimated cost 130. The estimated cost value enables a manufacturer to compare costs to produce the part using each different material, prior to manufacturing the part. The printability score enables the manufacturer to weigh how successfully the different attributes of the part will be reflected in the manufactured part, again, before the part is actually manufactured.

In some examples, the suitability of the part for another manufacturing technique, such as injection molding, may be already known. In this case, the methods 100A and 100B indicate whether the part is suitable for 3D printing. In one example, suitability for other manufacturing techniques may not be part of the analysis.

The method for analyzing 3D part printability and cost 100 further includes a user interface 124, in some examples. While the attributes 116 may be assigned based on the part data 104 (e.g., CSV file, similar parts spreadsheet), a user may also supply some characteristic information about the desired part. Thus, additions to both the attributes 116 and their weightings 120 may be received by way of the user interface 124. This user interface 124 may be utilized by the manufacturer or other user, for example, to facilitate entry of desired characteristics of the part being manufactured. By giving the user control over the weighting 120, the user is able to both indicate desired attributes 116 and enumerate the attributes according to their importance.

Further, in some examples, the user may provide representative information about the part, such as meta-data 106, CSV file 108, or similar parts spreadsheet 110, or other representative information not shown in FIGS. 1A and 1B, to be uploaded via the user interface. Thus, the user interface 124 is available, both to facilitate obtaining a complete record of information about the part 102 and to customize the analysis 114 of the part data 104, based on a list of desired attributes 116. In one example, the user interface 124 is implemented as a web application, mobile application, or desktop application, and the part data 104 and the analysis 114 are implemented as web services with application programming interfaces (APIs). In one example, the method 100 provides the printability score 126, which indicates suitability, and displays a set of object models, arranged according to score, e.g., highest score to lowest score or most suitable to least suitable.

FIG. 2 is a simplified diagram 200 of the user interface 124 that is part of the methods 100A and 100B of FIGS. 1A and 1B, respectively, according to examples. The user interface 124 enables any user to supply information to facilitate generation of the attributes 116 to be analyzed and the resulting printability score 126, which is a numerical value. The user interface 124 of FIG. 2 is merely representative of one type of user interface.

In the example user interface 124, user input such as part name 202 and part volume 204 are coupled to fillable text field boxes 204 and 208, respectively, for receipt of the part name and part volume (e.g., how many parts are to be made). An original material pull-down menu 210 includes a list of original materials 212 from which the user may make a selection. In an example, the pull-down menu 210 may, as a final selection, permit the user to select “other” and includes a text box that enables the user to specify a material not included in the list of available materials.

The user interface 124 also includes a file upload pull-down menu 214 that enables the user to upload files related to the part 102, such as the meta-data 106, CSV file 108, similar parts spreadsheet 110, object model 112, or other representations of the part. Particularly where the part has been previously manufactured, such representative data assists the methods 100A and 1008 in generating the attributes 116. Where the part is made of an assembly of two or more separately manufactured units, this information may also be supplied via the user interface. For such assembled parts, the cost analysis of competitive methods, such as injection molding, will also include an estimate of the cost of assembly, in one example.

The user interface 124 also includes pull-down menus 218 and 226 to enable the user to supply attribute and weighting information, respectively, for the part. Attribute characteristics 220 such as color, hardness, size, and cost are available for selection, and an additional pull-down menu 222 is available for any menu items featuring an arrow 224. In the example illustration 200, the color attribute may be selected as black, blue, brown, red, and so on. Each attribute may have a default value. For example, the color attribute may default to black.

In the weighting pull-down menu 226, the attributes 218 selected by the user are again featured, this time including an additional pull-down menu, or sub-pull-down menu, to select a weighting for each attribute. Thus, in the example illustration 200, the hardness weighting may be associated with a number 1, 2, 3, 4, and so on. This may be presented in a number of different ways. The number selection in the pull-down menu 230 may be limited to the number of attributes selected in the attribute pull-down menu 218. In such a configuration, the user weights each attribute in some order. Or, the menu selections in the second pull-down menu 230 may indicate a percentage.

In some examples, the weighting is an optional input of the user interface 124. In one example, a default weighting for an attribute is assigned automatically, such that no user input still results in a weighting for the attribute. In another example, some attributes have a default weight while other attributes have a different default weight. In another example, the weighting is based on the intended industry. For example, the aerospace industry may operate the method using a first set of weights while the medical industry operates the method using a second set of weights. In another example, the weighting is based on a use case. For example, the user may indicate that the part is intended to be used for fit and finish and thus, for the intended use, strength is not a factor. Or, the user may indicate that the part is to be used for production, in which case strength may become a factor. In another example, the user may selectively override the default weighting or the industry or case weighting by using optional inputs.

Web designers of ordinary skill in the art recognize a number of different schemes for implementing a suitable user interface to be used with the method 100. For example, the original material 210, attribute 218, and weighting 226 pull-down menus may instead be presented as a navigation bar from which the user makes selection. Or, the weighting pull-down sub-menu 230 may include slider bars to indicate weighting of an attribute, relative to other attributes. Or, the pull-down menus may be presented on different pages. Or, original material, attribute, and weighting information may be obtained by way of query-response menus. In examples, the user interface of the 3D part printability and cost method 100 is simple to use and enables the user to provide valuable information to facilitate part analysis.

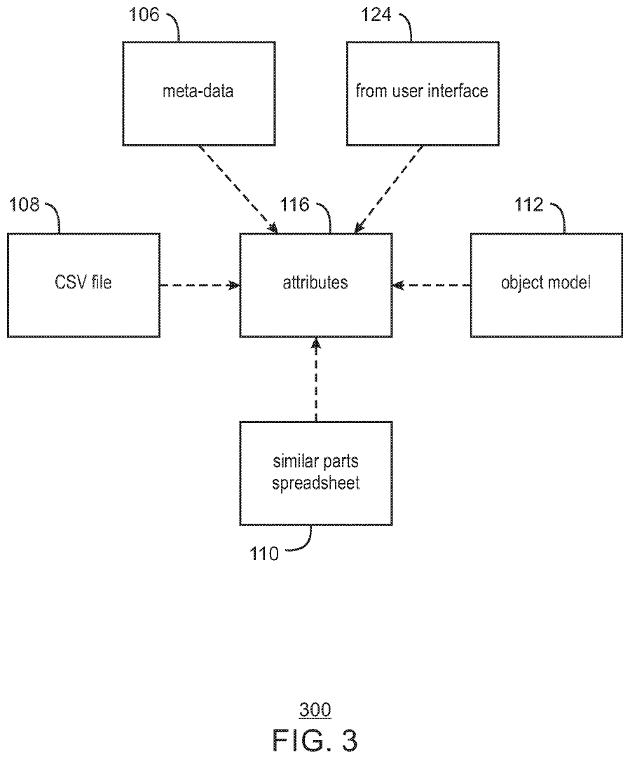

FIG. 3 is an illustration 300 of several ways in which the attributes 116 may be obtained and used by the method 100, according to examples. The user interface 124 enables the user to provide attributes about the part, such as by way of the file upload menu 214. In other examples, the attributes may be derived from meta-data 106, the CSV file 108, the similar parts spreadsheet 110, or from other information provided by the user. As another example, the attributes 116 may result from extracting and calculating the data from the object model 112 of the part.

In some examples, the attributes 116 may be categorized according to priority, with higher priority attributes being non-optional selections in the user interface, and lower priority attributes being optional selections. The more attributes provided by the user, the more precise the method 100 analysis may be. Attributes may include, but are not limited to, part volume, annual production volume, size of part in three dimensions, packing density, build volume, build height, weight, original material of the part, tensile strength, tensile modulus, tolerance, flammability, and color. One or more attributes may be derived from other attributes. For example, part weight may be calculated if the volume and original material are provided.

Recall from FIG. 1 that the analysis portion of the method 100 utilizes attributes, values assigned to each attribute, and weighting of the attributes, the latter two of which may be supplied by the user via the user interface, or are default values. The materials selection algorithm 122 is then executed upon this data to come up with the printability score 126 and estimated cost 130 associated with the part 102. Where more than one material is deemed suitable, in one example, the method balances the estimated cost with the printability score to choose a cost-effective approach that meets the printability specifications. In another example, rather than a single material being recommended, the recommended material 128 may be a list of top N materials, for integer N.

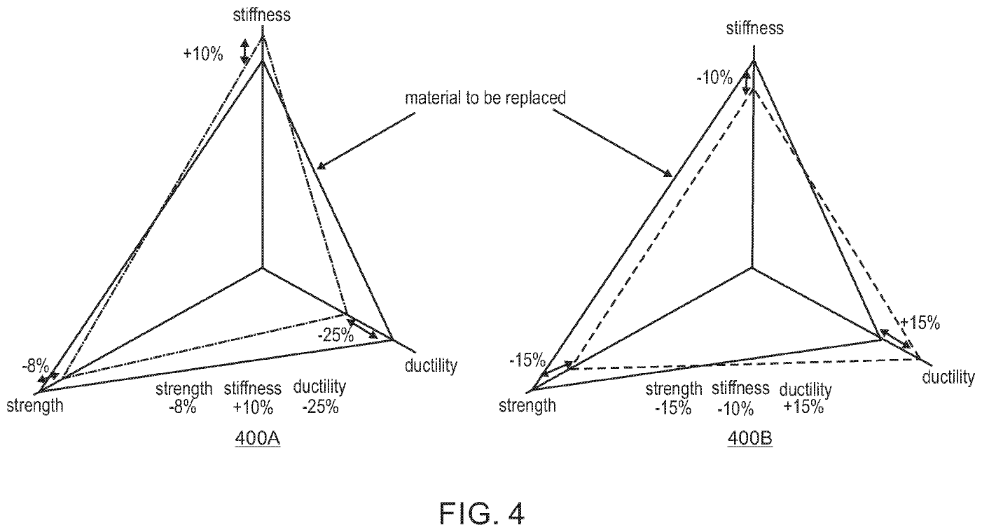

FIG. 4 is an illustration of two spider graphs 400A and 400B, that may be derived from the object model 112 of the part 102, and which may be used by the method 100 to perform analysis 114 of the attributes 116, according to examples. The spider graphs 400A and 400B provide a visual depiction of certain part attributes in relation to a selected material, so as to simplify the comparison of these attributes.

In FIG. 4, an original material (thick solid line), in other words, a material that may have been previously used, is to be replaced with one of two polymers, PA11 (dashed) or PA12 (dot-dashed). On the spider graph 400A, the original material is compared with PA12. On the spider graph 400B, the original material is compared with PA11. Each material is illustrated in three dimensions and looks like a triangle. For each material, the attributes of strength, ductility, and stiffness are plotted.

On the spider graph 400A, the original material triangle is compared to the PA12 triangle. The strength attribute of the PA12 material is 8% less than the strength attribute of the original material. The stiffness attribute of the PA12 material is 12% more than that of the original material. The ductility attribute of the PA12 material is 25% less than that of the original material. From the data represented visually by the spider graphs, the material selection algorithm 122 may be executed, to calculate the printability score 126 which is representative of the PA12.

On the spider graph 400B, the original material triangle is compared to the PA11 triangle. The strength attribute of the PA11 material is 15% less than the strength attribute of the original material. The stiffness attribute of the PA11 material is 10% less than that of the original material. The ductility attribute of the PA12 material is 15% more than that of the original material. From the data visually represented by the spider graph, the material selection algorithm 122 may be executed, to calculate the printability score 126 which is representative of the PA11.

Thus, based on the attribute data for both PA12 and PA11 materials, the material selection algorithm provides numerical representations, the printability score 126, of PA12 and PA11, with which a comparison may be made. In one example, the material selection algorithm, for each material, calculates the mean of the percent deviation of each attribute, with negative deviations being doubled, and, from the calculations, chooses the lower score (or lowest score, where more than two materials are compared). Thus, the printability score for PA12 polymer would be:

((8*2)+(10*1)+(25*2))/3=(16+10+50)/3=76/3=25.3

And the printability score for PA11 polymer would be:

((15*2)+(10*2)+(15*1))/3=(30+20+15)/3=65/3=21.7

Thus, according to the algorithm, PA11, with the lower printability score, would be selected over PA12 to replace the original material. The original material may be one that the manufacturer has used already, and thus has awareness of how well it performs, how much it costs, and so on. For the manufacturer, using polymers PA11 and PA12 may be unknown, so the data shown in FIG. 4 in which the attributes are expressed graphically may provide insight into whether those materials may successfully replace the original material.

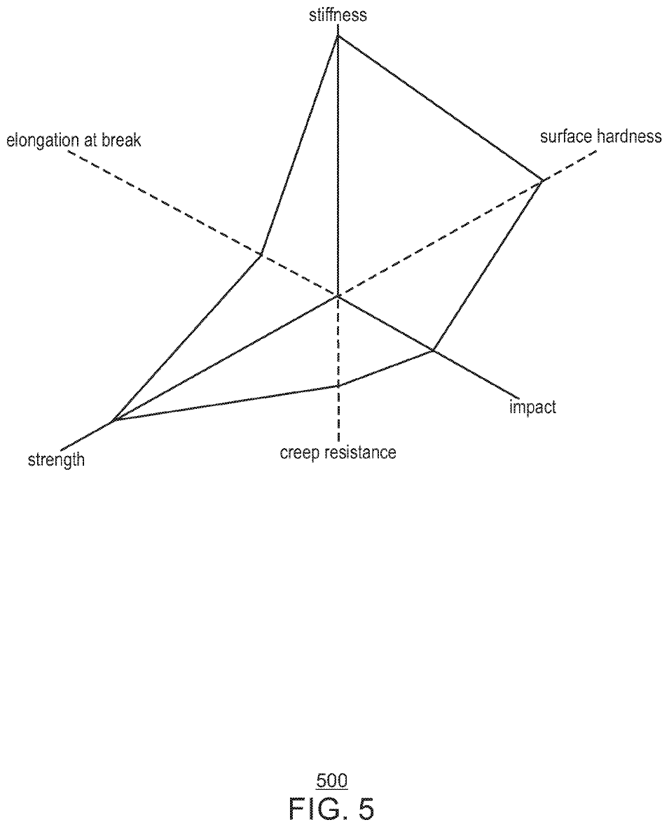

In the illustrations 400A and 400B, three attributes of the materials are visually represented, and thus the spider graphs feature triangles. It is possible, however, to compare many more than three attributes. FIG. 5, for example, shows a spider graph 500 of the PA12 polymer in which six attributes, stiffness, surface hardness, impact, creep resistance, strength, and elongation at break, are plotted. The spider graph 500 could be compared with other spider graphs of other materials as was done in FIG. 4.

In examples, the spider graphs assist the user in determining the suitability of the part for 3D printing. For some parts, a high printability score and low estimated cost make the decision straightforward. For other parts, the user will make an assessment based on how suitable the part is, based on how the 3D printed version will meet each of the attributes, given their own understanding of the how the part will be used.

Print Analysis

Thus, in one aspect, the 3D part printability and cost analysis method 100 arrives at a numerical value, the printability score, for a material, compares that value to one or more other numerical values, and arrives at a solution based on the comparison. The analysis may be of three attributes, such as in FIG. 4, six attributes, such as in FIG. 5, and so on. In one example, the printability analysis of the method 100 is based on a weighted printability score that includes attributes not including cost. A printability score of all parts may be plotted on the other axis.

In another example, the printability analysis may be assign a range of printability scores to categories. Thus, printability scores within a first range are deemed good or acceptable, scores in a second range are deemed bad or not acceptable, and scores in a third range are considered between good and bad. In another example, printability analysis is given as a 100-point score, where higher scores indicate better printability. Regardless of how the printability analysis is presented to the user, the analysis itself takes into account the available attributes of the part being analyzed.

Whatever the analysis, a part is not printable if its dimensions exceed the dimensions of the manufacturing target zone. For example, for additive manufacturing, the target zone may be a build or print bed, and with the size of the bed limiting the size of a part to be printed. Some 3D printers are very large, and others are a bit smaller. Because of these limitations, the size attribute of the part would thus have a high weighting during printability analysis. Thus, the 3D part printability and cost analysis method 100 enables a user to determine which devices are suitable for manufacturing a part. Where the size of the part being produced is relatively large, the method enables the selection of an appropriate printer whose target zone is larger than the part.

In some examples, the 3D part printability and cost analysis method 100 is also helpful when one or more possible characteristics (specified as attributes) of a part cannot be met, or when a heavily weighted attribute is missed by a small margin. For manufacturers who are familiar with one technology, such as injection molding, but are interested in exploring 3D printing, the analysis performed by the method may be helpful. For example, suppose a part was originally manufactured using ABS plastic, a common thermoplastic polymer. ABS plastic has a tensile strength of 48 MPa, but a different material used in 3D printing has a tensile strength of 40 MPa. The part may or may not actually need to be that strong. It is possible a lower tensile strength would be satisfactory. Using visual aids, such as the spider graph, to represent the data, the method 100 enables a human to evaluate the strength data relative to other known materials to facilitate such decision-making. Where the strength data is not very different between the known material and a proposed material, the spider graph provides a facile view of their similarities. Further, by weighting the various attributes, and by using the mean of the deviation, as in the above example of the material selection algorithm, small differences and relatively less favored attributes do not unduly affect the overall assessment of printability, in some examples.

As another example, suppose a user has specified an attribute as being high priority, such as a tolerance of 1.8 mm. A material used in 3D printing is close to that tolerance but doesn't technically pass, for example, having a manufacturing tolerance of 2.0 mm. This difference may be deemed acceptable. By weighting the attribute according to its priority and using the mean of the deviation in running the material selection algorithm, small differences do not unduly influence the printability score. On the other hand, the material selection algorithm may weight the tolerance heavily enough that a small difference in tolerance results in a printability score that results in the part not being printable. By producing the printability score, a numerical value, the method 100 provides information to enable a human to make a final decision on the printability of the part.

Recall that the 3D part printability and cost analysis method 100 employs attributes 116 that are assigned a value 118 and a weighting 120 during analysis 114. In one example, each attribute for consideration is given an equal weight by default. A user, via the user interface 124, may change these defaults and give one attribute a higher weight than another.

Cost Analysis

In addition to print analysis, cost analysis of a part can also be performed in support of different manufacturing methods. In particular, it is possible to estimate, for example, the cost of manufacturing by injection molding and by 3D printing. By generating the estimated cost 130 and knowing the volume of the part to be manufactured (which may be provided by the user in the part volume text field box 208 (FIG. 2), the 3D part printability and cost analysis method 100 enables an automated cost comparison of the two manufacturing methods to be performed, which identifies which parts are more cost effective to manufacture by injection molding versus additive manufacturing. Some manufacturers may give a higher weight to the cost attribute.

At a high level, injection molding can be determined by estimating the mold cost based on the weight and/or volume of the part along with the production volume, to determine the fixed cost component. There are well-known approaches to estimating injection molding costs. The 3D part printability and cost analysis method 100 exploits this known information, rather than recreating the information. Fixed costs can be allocated to each part, based on production volume.

In one example, 3D printer cost calculations are more complicated than injection mold cost calculations. The 3D part printability and cost analysis method 100 uses the dimensions of the part to estimate the number of parts per build, the, the height of the build, the number of requested builds, and, where more builds are requested than can be performed in a year, the number of needed printers. From the received data, the method determines the portion of fixed costs (of the printer, maintenance contract, rent, etc.) to be allocated to each part.

In another example, the 3D part printability and cost analysis method 100 uses the volume of the part to estimate the consumable supplies (e.g., agent, powder), where the agent may be a binder agent, a fusing agent, such as an ink-type formulation comprising carbon black, such as, for example, the fusing agent formulation commercially known as V10600 “HP fusing agent” available from HP Inc. In examples, such a fusing agent may additional comprise an infra-red light absorber, a near-infrared light absorber, a visible light absorber, an ultraviolet light absorber or a visible light enhancer. Examples of inks comprising visible light enhancers are dye-based colored ink and pigment-based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc. In one example, the 3D part printability and cost analysis method 100 may be used with chemical binder systems or metal type 3D printing.

The attributes may be adjusted based on per region, per product, per service plan. Optionally, the method runs a nesting algorithm to determine an optimized number of parts per build. The nesting algorithm is an algorithm to determine how many parts will fit in a build, as compared to more simplified assumptions based on packing density or bounding box math.

Also, optionally, the method runs the object model (e.g., the object model 112), if available, through commercially available 3D printer build software to more accurately determine consumables used. Instead of making assumptions about the amount of powder, fusing agent, coloring agent, and detailing agent based on the surface area and volume, the 3D printer build software actually decides on the materials and associated quantities, rather than relying on estimates. Detailing agent may also be used to control thermal aspects of a layer of build material, such as to provide cooling. While quick estimates (in microseconds) may be possible, such build software may take minutes or hours to generate a more accurate estimation by running the 3D model through the build system to determine the materials and agents used.

Using the injection molding cost per part cost, the 3D printer per part cost, and the production value, the 3D part printability and cost analysis method 100 compares 3D printing and injection molding manufacturing methods, and expresses the cost analysis as a ratio or as absolute cost savings. Here is an example of a ratio that may be used by the method 100:

$$ratio = \frac{p r i c e 3 D}{p r iceIM}$$

where price3D is the estimated price of the part via 3D printing and priceIM is the estimated price of the part via injection molding. Here is an example of cost savings calculation that may be used by the method 100:

Cost savings=(priceIM−price3D)*parts volume

When a plurality of parts is supplied, such as when an organization uploads tens of thousands of parts, the method employs both printability analysis and cost analysis to recommend which parts are the best candidates for 3D printer manufacturing, based on having both high printability and high cost savings potential.

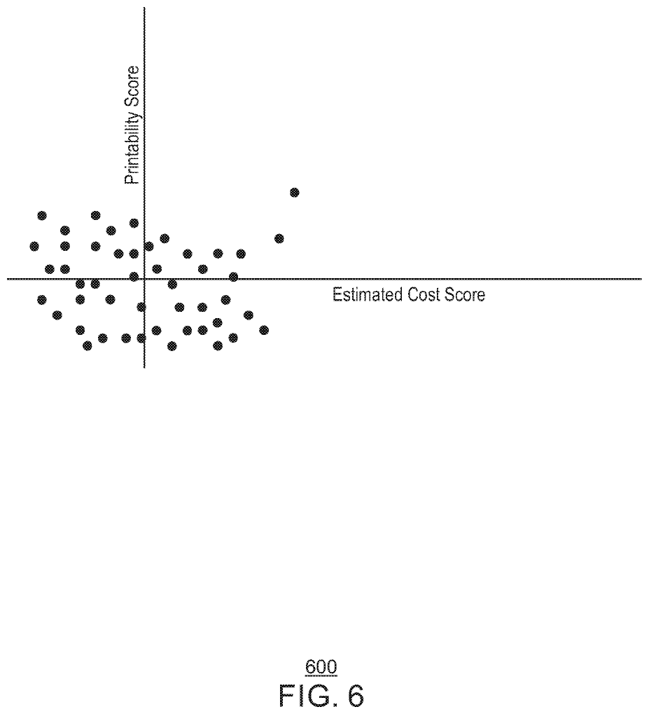

FIG. 6 is a graph 600 showing the estimated cost score (x-axis) versus the printability score (y axis) for a number of different parts analyzed by the 3D part printability and cost analysis method 100. Each dot represents a combination of the printability score 126 and the estimated cost 130 calculated by the method for the respective part. The estimated cost may be based strictly on either the cost ratio or the total savings, as described above. The printability score may be weighted to include everything except cost to generate. What results is the graph 600 in which one quadrant comprises parts that are both printable in terms of printability and cost effective, with the top right corner being both the most printable and the most cost effective for switching to 3D manufacture.

To determine the cost of a single part, the cost of a full build, e.g. the entire printing volume, is first calculated. For example, if the build box is one cubic foot, then, for 3D printing, one cubic foot of powder would be consumed. There will be a certain cost to the electricity to run the printer. There will be lamps that may need to be replaced every so many builds, and so on. Each of these prices will vary depending on where the printer is sold (e.g., US, UK, Germany, etc.).

There are also costs based on the volume of each part. A part that is one cubic millimeter in size will consume a certain amount of liquid agent, depending on the surface area and internal volume. A full build will fit a certain number of parts, depending on how well those parts fit together (e.g., are nested according to a nesting algorithm.

For example, consider printing disposable plastic cups, which could nest partially inside each other, in contrast with solid shapes of the same outside dimension. Vastly more disposable plastic cups will fit in a full build, as compared to solid objects of the same shape, due to the disposable plastic cups being nestable inside one other during the build.

So, the cost is a function of the fixed costs of the printer amortized over a period of time, which implies a certain number of builds, and also depends on assumptions about the number of days per year and hours per day the printer is utilized, the cost of a full build split among the parts in the build, and the variable cost of each part.

The 3D part printability and cost analysis method 100 is fast and automated, in some examples. By offering a web-based user interface and the ability to upload CSV files meta-data, an object model, and so on, it is possible to analyze millions of parts per hour. The 3D part printability and cost analysis method 100 is thorough. Combining both printability analysis and cost analysis helps determine one or more candidates for 3D printing, and helps triage through many parts. The 3D part printability and cost analysis method 100 is simple. By using meta-data rather than 3D model analysis, the analysis can be done even when 3D models don't exist, or when they are not available. The 3D part printability and cost analysis method 100 is accurate. In some examples, the meta-data approach is more accurate than simple rule-of-thumb calculations.

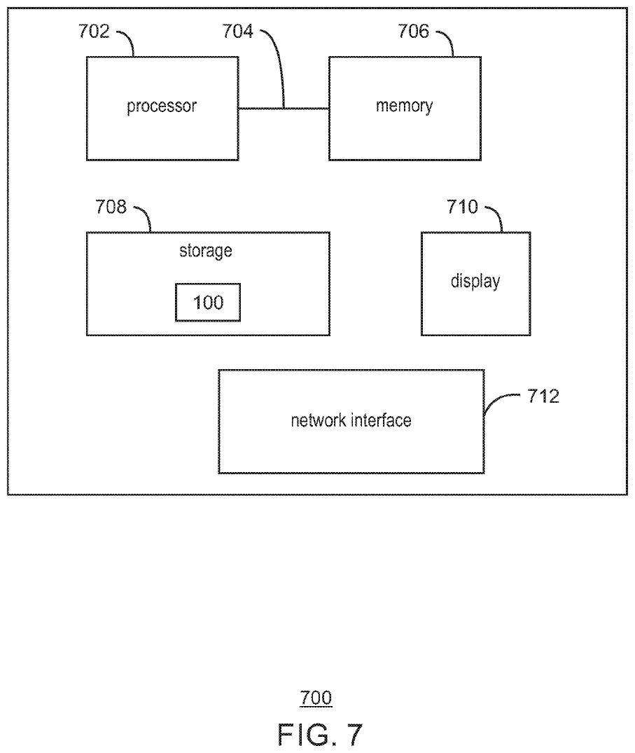

FIG. 7 is a simplified block diagram of a system 700 to perform the 3D part printability and cost analysis method 100 of FIG. 1, according to examples. The system 700 is a processor-based system, such as a laptop or desktop computer. A memory device 706 is coupled to the processor 702 via a bus 704. Programs loaded into the memory 706 may be executed by the processor 702. A non-volatile storage device 708 stores the method 100 as a software program. A display 710 enables the user interface from FIG. 1 to be presented. The system 700 may be integrated as shown, or may be distributed such that the user interface is remote to the system and accessible through the network interface 712.

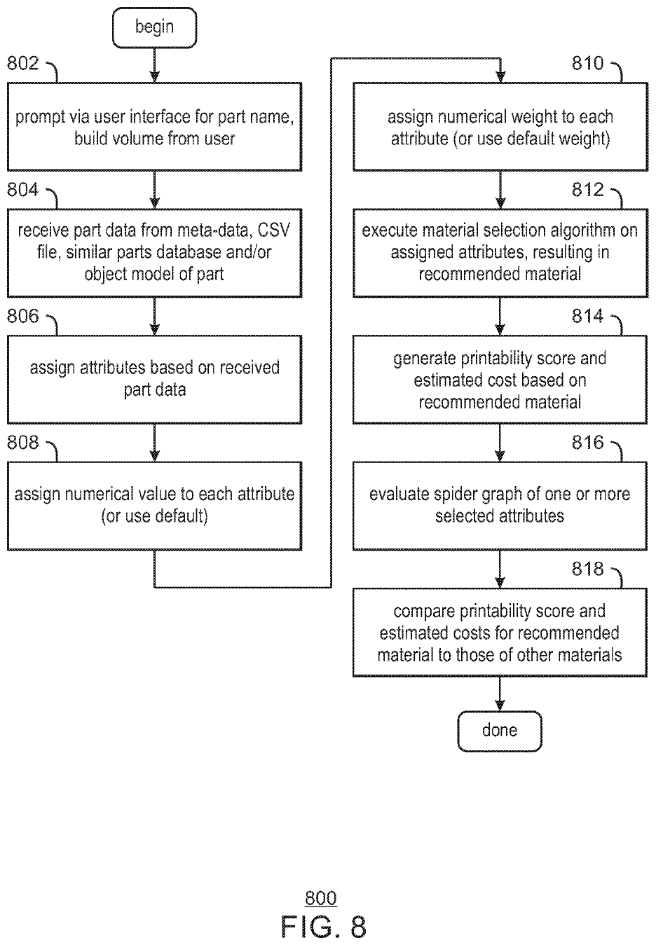

FIG. 8 is a flow diagram showing operations performed by the 3D part printability and cost analysis method 100 of FIG. 1 or by the system 700 of FIG. 1 implementing the 3D part printability and cost analysis method. The operations depicted in FIG. 8 may take place in an order other than is presented, and one or more of the operations may be optionally performed. Via the user interface, the user is prompted to supply part name and build volume of the part (block 802). Data relating to the part is also received, such as from meta-data, CSV file, similar parts database, and/or an object model of the part (block 804). Attributes are assigned based on the received part data (block 806). Numerical values are assigned to each attribute, unless default values are used (block 808). Numerical weights are also assigned to each attribute, unless defaults are used (block 810).

Based on the received data about the part, the material selection algorithm is executed, based on the numerical values of the attributes and the numerical weights, resulting in a recommended material 128 (block 812). From the recommended material, a printability score and estimated cost are generated (block 814). Where an object model is available, a spider graph of selected attributes may also be generated (block 816). This enables a visual evaluation of the part that may enhance the analysis of the part data. The printability score and estimated cost for the recommended material may also be compared to that of other materials (block 818).

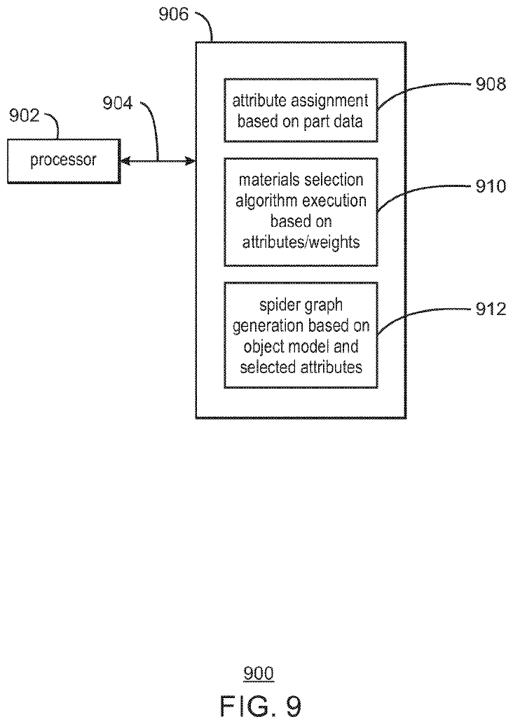

FIG. 9 is a block diagram of a non-transitory, machine-readable medium 800 for performing the 3D part printability and cost analysis method, in accordance with examples. A processor 902 may access the non-transitory, machine readable medium over a reader mechanism, as indicated by arrow 904.

The non-transitory, machine readable medium 900 may include code 906, specifically modules 908, 910, and 912, to direct the processor 902 to implement operations for performing the 3D part printability and cost analysis method of a part to be 3D printed or injection molded. Attribute assignment based on part data 908, for example, collects part data and assigns attributes with numerical values as well as weightings, as described above. Materials selection algorithm execution 910 takes the weighted attributes and recommends a material based on the attributes. Further, a printability score and estimated cost for the recommended material are calculated. Spider graph generation 912, is based on an object model (if available) and selected attributes.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method comprising:
analyzing one or more attributes of a part to be manufactured based on received data about the part, wherein a weight is assigned to each attribute;
calculating a printability score of the part based on the one or more weighted attributes, wherein the printability score is a numerical value; and
calculating an estimated cost to three-dimensional (3D) print the part based on the one or more attributes;
wherein the printability score and the estimated cost are used to evaluate whether to 3D print the part.

2. The method of claim 1, further comprising:
recommending a material to be used to 3D print the part based on the one or more attributes;

3. The method of claim 1, further comprising:
receiving a volume of the part to be manufactured, wherein the printability score and estimated cost are based on the volume.

4. The method of claim 3, further comprising:
calculating the printability score based on the assigned one or more attributes and respective weights as well as the recommended material.

5. The method of claim 1, further comprising:
generating a spider graph of selected attributes of the one or more attributes of the part based on an object model of the part.

6. The method of claim 1, wherein the received part data comprises meta-data of the part.

7. The method of claim 1, wherein the received part data comprises a comma separated value (CSV) file or similar parts spreadsheet of the part.

8. The method of claim 1, wherein the received part data comprises an object model of the part.

9. A method comprising:
receiving a plurality of object models of a part to be manufactured;
receiving a plurality of attributes of the part, each attribute comprising a relative weighting;
analyzing the plurality of object models and plurality of weighted attributes; and
for each of the plurality of object models, generating a printability score and estimated cost to additive manufacture the part based on the analysis;
wherein the plurality of object models is arranged according to the printability score of each, from most suitable object model to least suitable object model.

10. The method of claim 9, further comprising:
recommending a plurality of suitable materials based on the printability scores and cost estimates.

11. The method of claim 10, further comprising:
generating a spider graph from an object model of the plurality of object models based on two or more attributes of the plurality of attributes and a first material of the recommended plurality of suitable materials;
generating a second spider graph from the object model based on the two or more attributes and a second material of the recommended plurality of suitable materials, wherein the first and second spider graphs enable visual comparison of the first material and the second material in view of the two or more attributes.

12. A machine-readable medium having instructions stored therein that, in response to being executed on a computing device, cause the computing device to:
analyze a plurality attributes of a part to be manufactured based on received data about the part, wherein a numerical value and weight are assigned to each of the plurality of attributes;
recommending a material to be used for the manufacture of the part based on the weighted plurality of attributes;
calculating a printability score of the part based on the recommended material; and
calculating an estimated cost to three-dimensional (3D) print the part based on the recommended material;
wherein the printability score and the estimated cost are used to evaluate whether to 3D print the part.

13. The machine-readable medium of claim 12, further causing the computing device to:
assign the weight for each of the plurality of attributes based on a default value.

14. The machine-readable medium of claim 13, further causing the computing device to:
prompt a user, via a user interface, to upload meta-data, a comma separated values file, or an object model of the part, wherein the plurality of attributes are obtained based on the uploaded information.

15. The machine-readable medium of claim 12, further causing the computing device to:
calculate a second printability score and a second estimated cost for a second material based on the assigned attribute and weight for the attribute; and
select between the material and the second material based on:
a comparison between the printability score and the second printability score;
a second comparison between the estimated cost and the second estimated cost; or
both the comparison and the second comparison.
